(19) United States
(12) Patent Application Publication
(10) Pub. No.: US 2015/0144777 A1
(43) Pub. Date: May 28, 2015

(54) MULTIPLE SOLID PHASE MICRO-EXTRACTION THERMAL DESORPTION IONIZATION DEVICE, MASS SPECTROMETER AND ANALYTICAL METHOD FOR MASS SPECTROMETRY

(71) Applicant: National Sun Yat-sen University, Kaohsiung (TW)

(72) Inventors: Jen-taie SHIEA, Kaohsiung (TW); Min-zong HUANG, Kaohsiung (TW); Jo-han CHOU, Kaohsiung (TW)

(73) Assignee: National Sun Yat-sen University

(21) Appl. No.: 14/298,923

(22) Filed: Jun. 8, 2014

(30) Foreign Application Priority Data
Nov. 28, 2013 (TW) 102143464

(51) Int. Cl. H01J 49/04; H01J 49/00

(52) U.S. Cl. CPC H01J 49/049; H01J 49/0463; H01J 49/0027
USPC 250/282; 250/288

(57) ABSTRACT

A multiple solid phase microextraction (m-SPME) thermal desorption ionization device which desorbs an analyte and moves it into an entry of a mass spectrometer for mass spectrometry analysis is provided. The device has a charge producing unit, a heating unit and a sampling unit. The sampling unit provides a plurality of probes. The analyte is attached to the probes, and then the probes are inserted through a passage of the heating unit to instantly vaporize the analyte for ionization and analysis in conjunction with the charge producing unit and the mass spectrometer. Thus, the time needed for analyte analysis is shortened. A mass spectrometer system having the thermal desorption ionization device and an analytical method for mass spectrometry are also provided.

### CROSS REFERENCE TO RELATED APPLICATIONS

This application claims a priority from Taiwan Patent Application No. 102143464 filed on Nov. 28, 2013. This invention is partly disclosed in a thesis entitled “Solid Phase Microextraction (SPME) coupling with Thermal Desorption Electrospray Ionization Mass Spectrometry (TD-ESI/MS) for Efficiently Tracing Small Chemical Compounds in Liquids and Solids” in a conference on Jun. 9-13, 2013 completed by Jen-Taie Shiea, in a thesis entitled “Development of Solid-Phase Microextraction (SPME) Coupled with Ambient Mass Spectrometry for Rapidly Characterizing Trace Emerging Contaminants in Aqueous Samples” in a conference on Jul. 10-12, 2013 completed by Jen-Taie Shiea, and in a thesis entitled “Solid Phase Microextraction Coupled with Ambient Mass Spectrometry to Rapid Trace Emerging Contaminants in Water” in a conference on Oct. 14-15, 2013 completed by Jen-Taie Shiea.

### FIELD OF THE INVENTION

The present invention relates to an ionization device, in particular to a thermal desorption ionization device having multiple solid phase micro-extraction probes. The present invention also relates to a mass spectrometer system including the thermal desorption ionization device, as well as an analytical method for mass spectrometry.

### BACKGROUND OF THE INVENTION

Through analytical technique of mass spectrometry, the molecular weight of an analyte can be obtained, and then the analyte can be further identified through comparison. Thus, mass spectrometers utilizing the analystical technique of mass spectrometry have been used widely as an identifying tool in various areas since the early 20th century, because of the advantages of easy operation and detection results which are obtained quickly.

In 1997, the applicant connected a seven-tube multi-channel electrospray ionization device with a gas chromatograph for the separation and detection of an ester mixture with seven different molecular weights. The related technologies are described by reference to the following thesis: C. S. Wang, J. Shiea, J. Mass Spectrom. 1997; 32: 247.

In 2000, the applicant then connected the multi-channel electrospray ionization (MC-ESI) device to a flow pyrolyzer, used the device directly to detect unstable compounds, such as ketene, generated by pyrolysis, and used the FP/MC-ESI/MS device easily and quickly to detect pyrolysis. The related technologies are described by reference to the following thesis: C. M. Hong, F. C. Tsai, J. Shiea, Anal. Chem. 2000; 72: 1175.

In 2002, the applicant proposed the fused droplet electrospray ionization (FD-ESI) method, also known as the two-step electrospray ionization method, and subsequently developed various ionization methods. Unlike electrospray ionization mass spectrometry, after the pretreatment of an analyte, the analyte is directly pumped through a capillary applied with a high voltage, and is electrosprayed at the end of the capillary for analyte ionization. The process is accomplished first by using an atomizer (ultrasonic atomizer or pneumatic atomizer) to atomize the analyte solution to droplets whose sizes are 10-30 μm. These tiny droplets and the charged droplets generated by electrospray are fused to produce the charged analyte ions. For the design of the electrospray ionization source, the single capillary is substituted for the multiple channels to perform an electrospray, and became the main design for the subsequent ionization source. The related technologies are described by reference to the following theses: (1) D. Y. Chang, C. C. Lee, J. Shiea, Anal. Chem. 2002; 74: 2465. (2) C. C. Lee, D. Y. Chang, J. Y. Jeng, J. Shiea, J. Mass Spectrom. 2002; 37: 115.

In 2005, the applicant then developed another electrospray-assisted pyrolysis mass spectrometry (ESA-Py/MS) for analysis of macromolecular, including soluble and non-soluble synthetic polymers and natural polymer materials, including rapid analysis and identification of crude oil, amber, and humus. The related technologies are described by reference to the following theses: (1) H. J. Hsu, T. L. Kuo, S. H. Wu, J. N. Oung, J. Shiea, Anal. Chem. 2005; 77: 7744.(2) H. J. Hsu, J. N. Oung, T. L. Kuo, S. H. Wu, J. Shiea, Rapid Commun. Mass Spectrom. 2007; 21: 375.

However, the device described above is too large, and not easy to operate. In addition, the sample injection process is complicated. In the sample analysis process, the sample entered a heating device, and is heated to the predefined temperature. After a carrier air flow is fed through a sample channel, the vaporized analyte is directed by heat to an area for ionization. Therefore, not only is the operation inconvenient and time-consuming, but some of the sample is lost in the transferring process and left residue on the wall of the channel.

Furthermore, ambient mass spectrometry has the advantages of a direct, rapid, real-time and high-throughput analysis. The surface of a sample can be ionized and detected directly under one atmospheric pressure, and the pre-treatment process of the sample is almost not required. Compared with the complicated pretreatment and separation processes of samples required in conventional analyses, analysis time is saved, and analysis efficiency is effectively increased.

Though the ambient mass spectrometry offers so many advantages, the application thereof is limited to the rapid screening of the qualitative analysis. It is still required to develop new methods to achieve the quantitative analysis and the reproducibility of the conventional analyses. This problem mainly derives from the sample without pre-treatment, resulting in the decreased detection sensitivity. In particular, samples containing complicated matrices cause more serious interferences. Moreover, since the sample is directly analyzed, the amount of each sample used for analysis is not controlled easily and accurately, resulting in a deviation in reproducibility and a decrease in the precision of quantitative analysis.

### SUMMARY OF THE INVENTION

Accordingly, the object of the present invention is to provide a thermal desorption ionization device which includes multiple solid phase micro-extraction probes, has smaller overall size, and provides rapid sampling, rapid analysis, high precision and high reproducibility.

Therefore, the present invention provides a thermal desorption ionization device having multiple solid phase micro-extraction probes for desorbing an analyte, and moving the analyte toward an entry of a mass spectrometer for mass spectrometry analysis. The thermal desorption ionization device comprises a charge producing unit, a heating unit and a sampling unit.

The charge producing unit is disposed separately from the mass spectrometer and faces the entry of the mass spectrometer for producing charged solvent droplets. The heating unit includes a heating body and a passage penetrating through the heating body. The passage includes a sample inlet and an outlet opposite to the sample inlet, and the outlet faces a space between the charge producing unit and the mass spectrometer, and the extending direction of the outlet intersects the extending direction of the charge producing unit. The sampling unit includes a plurality of probes which are combined together, can be inserted into and pulled away from the passage of the heating unit, and can be attached by the analyte, wherein each of the probes comprises a fused silica fiber or a metal fiber, and is coated with a polymeric adsorption material.

The second object of the present invention is to provide a mass spectrometer system, including a mass spectrometer having an entry and the thermal desorption ionization device described in the first object.

The third object of the present invention is to provide an analytical method for mass spectrometry, comprising a sampling step, a desorbing step, a charge producing step, and an analysis step.

Classical solid phase microextraction (SPME) uses passive diffusion to collect and partition headspace compounds onto a coated fiber/filament. The sampling step is to extract an analyte with or attach an analyte onto a plurality of probes combined together, so that the analyte is attached to the probes, wherein each of the probes comprises a material selected from a group consisting of a fused silica fiber and a metal fiber, and is coated with a polymeric adsorption material. The desorbing step is to insert the probes into a passage penetrating through a heating body. The analyte attached to the probes is heated, desorbed into a gas state by the heating body, and leaves the passage. The charge producing step is to face a charge producing unit towards the entry of the mass spectrometer in order to produce charged solvent droplets. The analyte in the gas state and the solvent droplets are fused to generate the charged analyte ions. The analysis step is to allow the analyte ions to enter the mass spectrometer via the entry, and the analyte ions are analyzed by the mass spectrometer to generate a mass spectrum.

The advantages of the present invention are that: an analyte in a liquid or solid state is extracted onto a plurality of probes, and the probes are inserted into the passage of the heating unit to instantly vaporize the analyte for ionization and mass spectrometry analysis, which shortens the analysis time of the analyte. Sampling with a plurality of the probes not only increases the sampling efficiency and the analysis sensitivity, but also detects different components or materials in the same sample.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram illustrating a mass spectrometer system in accordance with a preferred embodiment of the present invention.

FIG. 2 is a flow chart illustrating an analytical method for mass spectrometry in accordance with a preferred embodiment of the present invention.

FIGS. 3A-3C, 4A-4B, 5A-5F and 6A-6D are spectra illustrating the analysis results in accordance with experiments of the present invention.

FIGS. 7 and 8 are histograms illustrating that in the present invention, there are positive correlations of experimental results with the increase in the number of probes and with the increase in the duration of contact between the probes and an analyte.

### DETAILED DESCRIPTION OF THE PREFERRED EMBODIMENTS

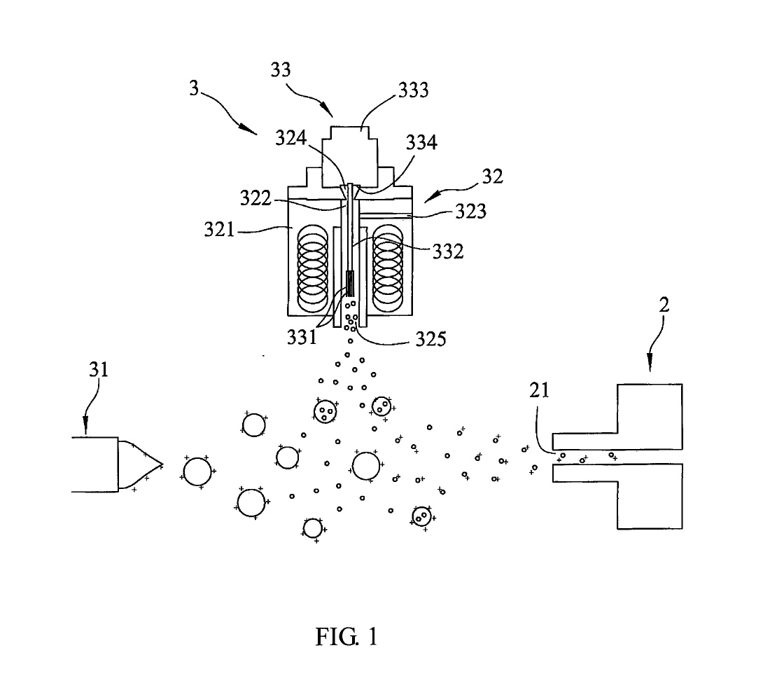

Referring to FIG. 1, the mass spectrometer system includes a mass spectrometer 2 having an entry 21, and a thermal desorption ionization device 3 according to the preferred embodiment of the present invention. The structure of the mass spectrometer 2 is known by a person of ordinary skill in the art, and is not described here redundantly. The thermal desorption ionization device 3 includes a charge producing unit 31, a heating unit 32, and a sampling unit 33.

The charge producing unit 31 is disposed separately form the mass spectrometer 2 and faces the entry of the mass spectrometer 2 for producing charged solvent droplets. It is noted that in this embodiment, the charge producing unit 31 produces the charged solvent droplets in a spraying method, and the spraying method comprises a method selected from a group consisting of electrospray ionization, nanospray ionization, sonic spray ionization, and thermal spray ionization. The charge producing unit 31 the charge producing unit also produces the charged solvent droplets in an electric discharge method, and the electric discharge method comprises a method selected from the group consisting of corona discharge, glow discharge, and dielectric barrier discharge.

The heating unit 32 includes a heating body 321, a passage 322 penetrating through the heating body 321, and an air flow path 323 penetrating through a heating body and intersecting the passage 322. The heating temperature range of the heating body of the heating unit is from 40° C. to 1500° C. The passage 322 includes a sample inlet 324 and an outlet 325 opposite the sample inlet 324, and the outlet 325 faces a space between the charge producing unit 31 and the mass spectrometer 2, and the extending direction of the outlet 325 intersects the extending direction of the charge producing unit 31.

The sampling unit 33 includes a plurality of probes 331 which are combined together and can be inserted into and pulled away from the passage 322 of the heating unit 32, a connector 332 connecting one end of the probes 331, and a fixing portion 333 connecting one end of the connector 332 away from the probes 331. An analyte in a liquid or solid state is extracted onto a plurality of the probes 331 (not shown in figures), so that a part of the analyte is attached to the probes 331. The fixing portion 333 has a connecting area connecting to the connector and facing the sample inlet, and the connecting area is larger than the cross-section of the sample inlet.

Each of the probes 331 is made from fused silica fibers or metal fibers and coated with a polymeric adsorption material. In this invention, the method for obtaining analytes through a plurality of probes 331 is called “solid phase microextraction (SPME)”. The technique achieves the equilibrium of an analyte between adsorption and desorption by coating a polymeric adsorption material onto fused silica fibers or metal fibers. It also is combined with the sampling, extracting, concentrating and analyte-injecting technique for significantly reducing the use of organic solvents, simplifying the procedures of the analyte pre-treatment to reduce the analysis time. In this embodiment, the polymeric adsorption material is selected from either polyacrylate (PA) or polydimethylsiloxane (PDMS).

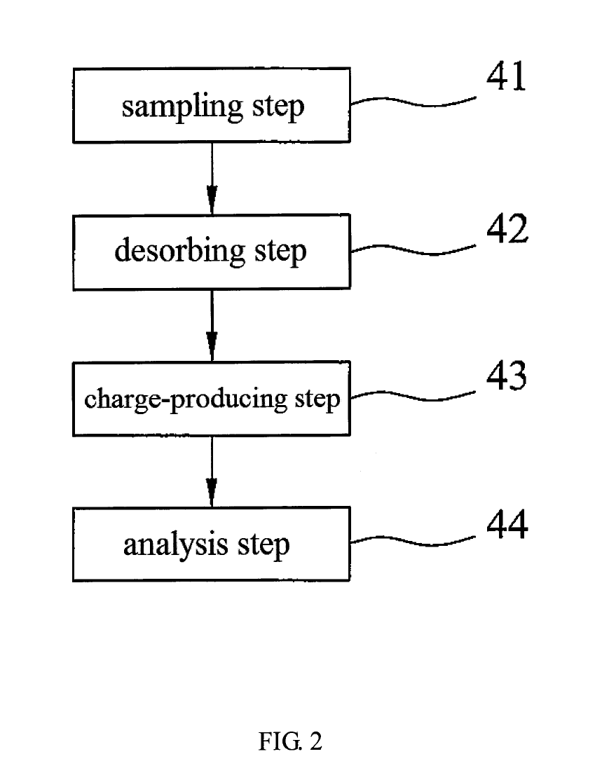

FIG. 2 shows an analytical method for mass spectrometry according to the preferred embodiment of the present invention. The method for an analyte analysis through the foregoing mass spectrometer system includes a sampling step 41, a desorbing step 42, a charge producing step 43, and an analysis step. Referring to FIG. 1 and FIG. 2, the procedures of the analytical method for the mass spectrometry through the mass spectrometer are described.

The sampling step 41 is to attach an analyte to the probes 331. The attachment method can be that the probes 331 are placed directly into the analyte in a liquid state for a period of time, so that the analyte in a liquid state is coated onto the probes 331, or the analyte in a liquid state is heated and vaporized into a gas state, so that the analyte in a gas state is coated onto the probes 331.

The desorbing step 42 is to insert the probes 331 through the sample inlet 324 into a passage 322, so that the analyte attached to the probes 331 is heated, desorbed into a gas state by the heating body 321, and leaves the passage 322.

The charge producing step 43 is to face a charge producing unit 31 towards the entry 21 of the mass spectrometer 2 in order to produce charged solvent droplets. The analyte in the gas state is carried by air to the solvent droplets to react and undergo post-ionization, and then ion-molecular reaction (IMR) to generate charged analyte ions. The analysis step 44 is to allow the analyte ions to enter the mass spectrometer 2 via the entry 21, and to analyze the analyte by the mass spectrometer.

The user may adjust the heating temperature of the heating body 321 based on the different nature of analytes to ensure that the analytes are heated and vaporized into a gas state and leave the passage 322. Not only does the design of the fixing portion 333 allow the user easy operation, but the contact area 334 of the fixing portion 333 is greater than the cross-section of the sample inlet 324 for preventing all the probes 331 from falling in the passage 322 when the probes 331 are inserted into the passage 322.

It is noted that in this embodiment, the heating temperature range of the heating body 321 is from 40° C. to 800° C. This temperature range is only an exemplary operating condition of this embodiment. Certainly, it is possible to heat to more than 800° C., even up to about 1500° C. depending on the actual operating conditions. The disclosure of the embodiment should not be regarded as limiting.

Based on the design of the sampling unit 33 including a plurality of probes 331 in this invention, a large amount of an analyte can be obtained in one scraping or attaching action. Therefore the efficient sampling produces rapid screening analysis, improves measurement sensitivity, and lowers the minimal limit of the detection.

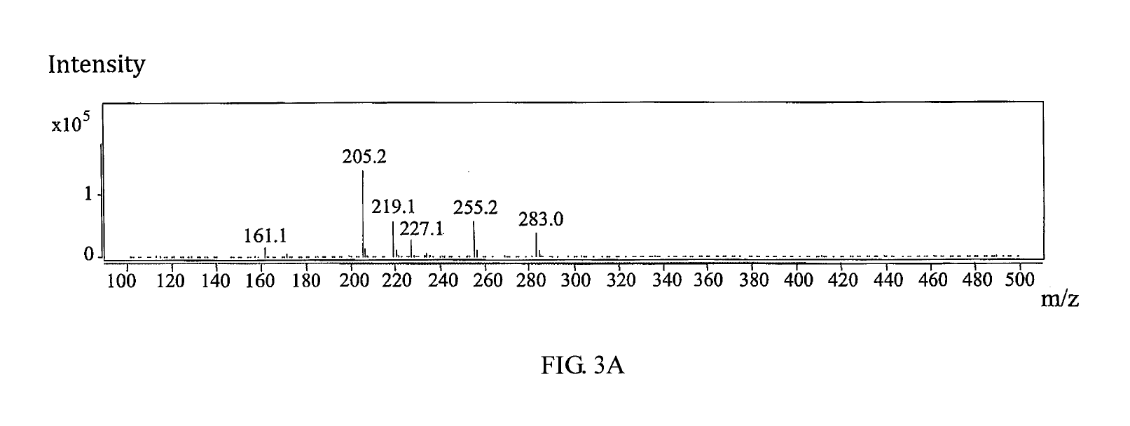

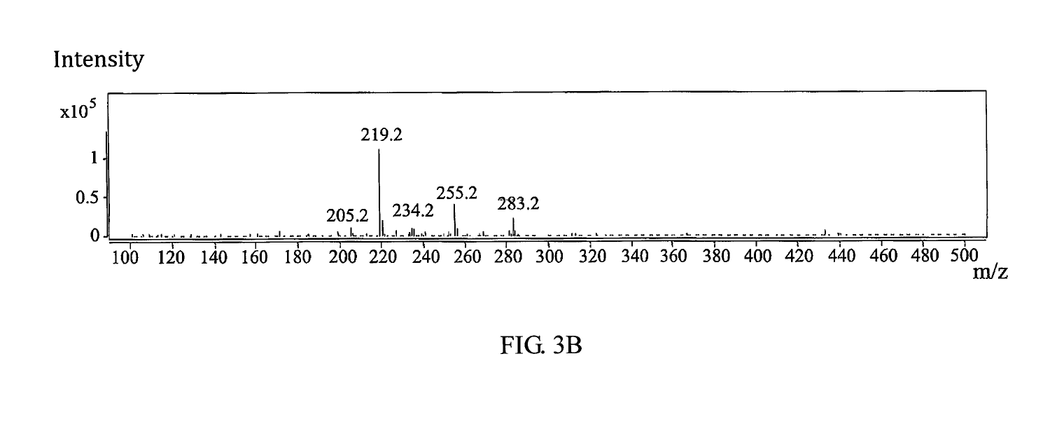

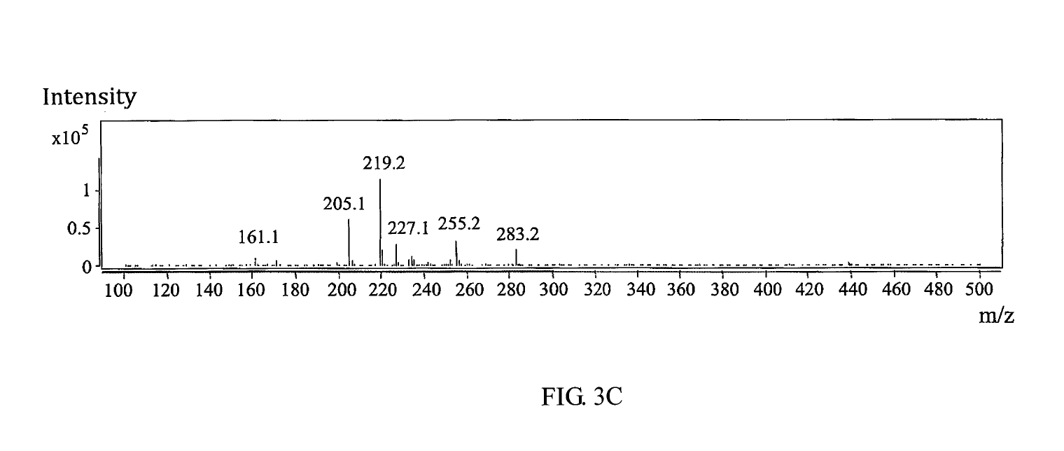

FIG. 3A to FIG. 8 show the exemplary experiments of the measurements based on the device and method in the invention. The mass spectrometer system as shown in FIG. 1 and the analytical method as shown in FIG. 2 are used in all measurements.

Referring to FIGS. 3A-3C accompanying FIG. 1, the probes 331 coated with different polymeric adsorption materials are used to measure the mixed solution containing Ibuprofen (m/z=205, more polar), Bisphenol A (m/z=227, more polar), and Nonylphenol (m/z=219, more non-polar). FIG. 3A shows the results measured by all the probes 331 coated with polyacrylate (PA). FIG. 3B shows the results measured by all the probes 331 coated with polydimethylsiloxane (PDMS). FIG. 3C shows the results measured by half of the probes 331 coated with polyacrylate (PA), and half of the probes 331 coated with polydimethylsiloxane (PDMS). According to the results above, polyacrylate (PA) is suitable to adsorb polar analytes, and polydimethylsiloxane (PDMS) is suitable to adsorb non-polar analytes. Thus, suitable coating materials of the probes 331 can be selected depending on the nature of the analytes.

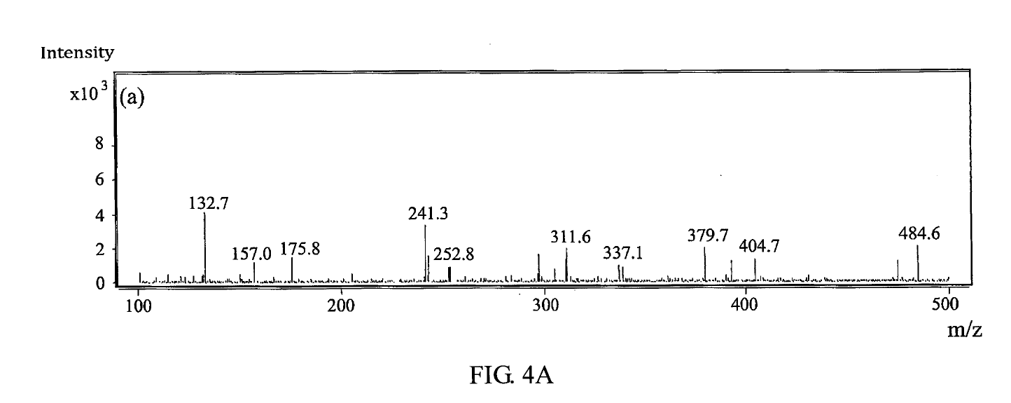

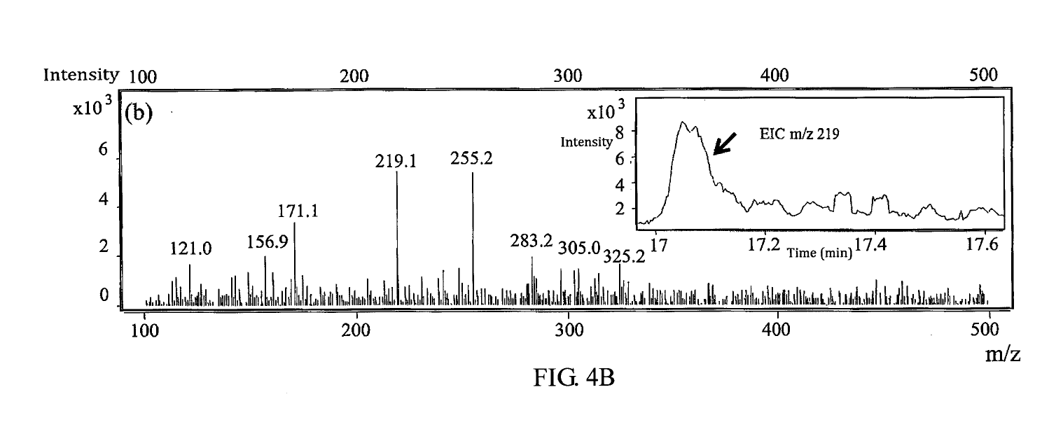

As shown in FIGS. 4A-4B, nonylphenol (EIC m/z219) is measured respectively by using a conventional single probe 331 to first perform the analyte adsorption, and then the thermal desorption electrospray ionization mass spectrometry (TD-ESI/MS), and by using a plurality of the probes 331 combined together in the present invention to directly perform solid phase microextraction, and then the thermal desorption electrospray ionization mass spectrometry (SPME-TD-ESI/MS). As shown in FIG. 4B, it can be seen that the low concentration, 100 ppt (parts per trillion), can be detected by SPME-TD-ESI/MS, but such a low concentration can not be detected directly by TD-ESI/MS. Therefore, the detection sensitivity in the invention is quite high.

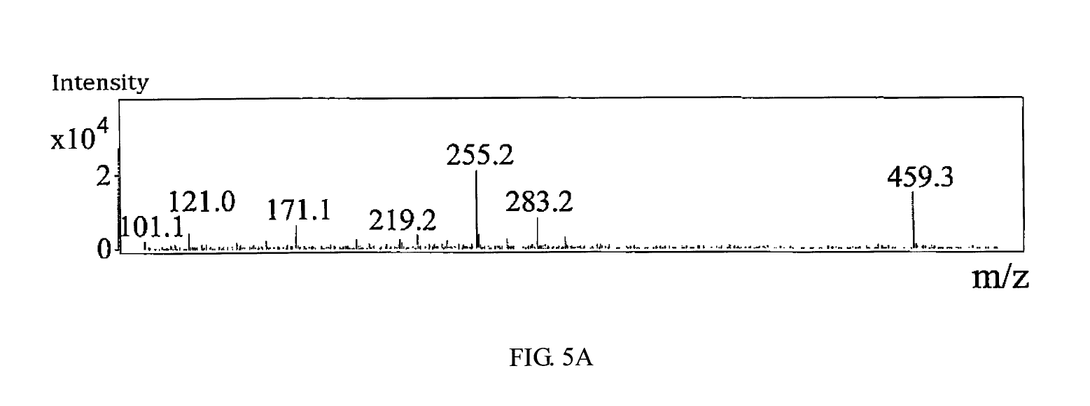

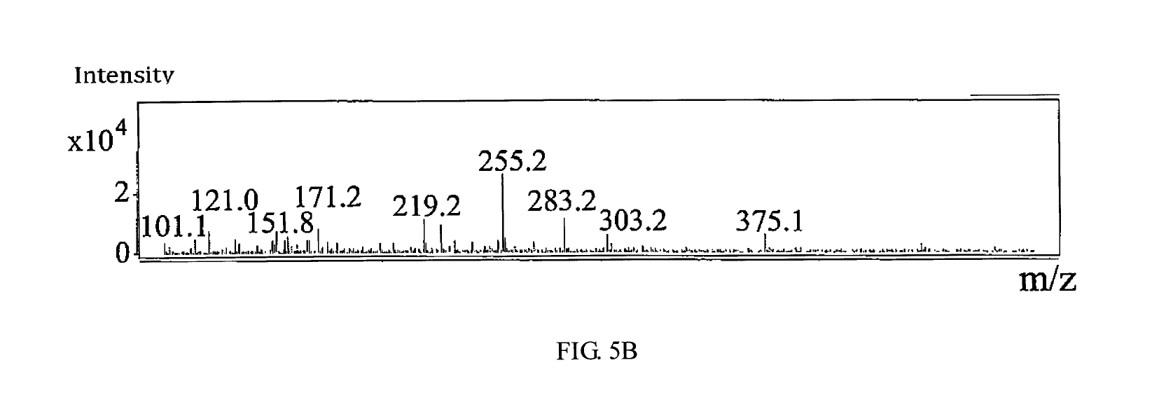

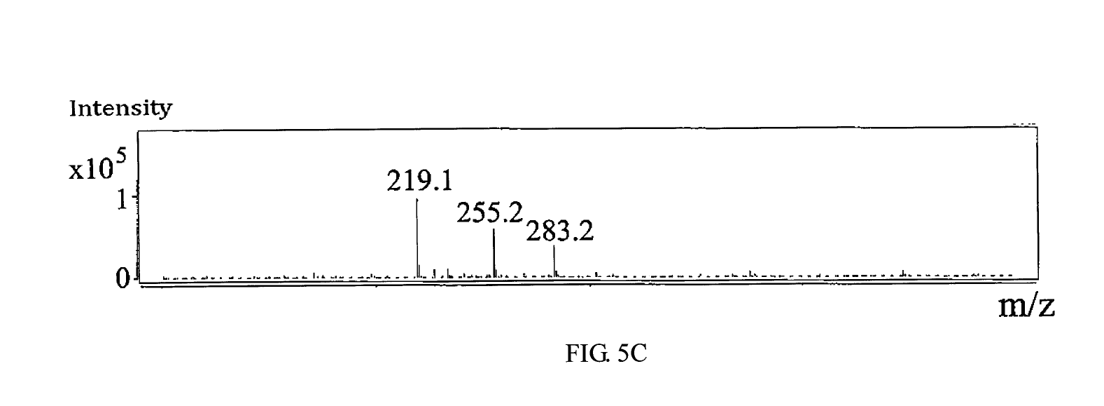

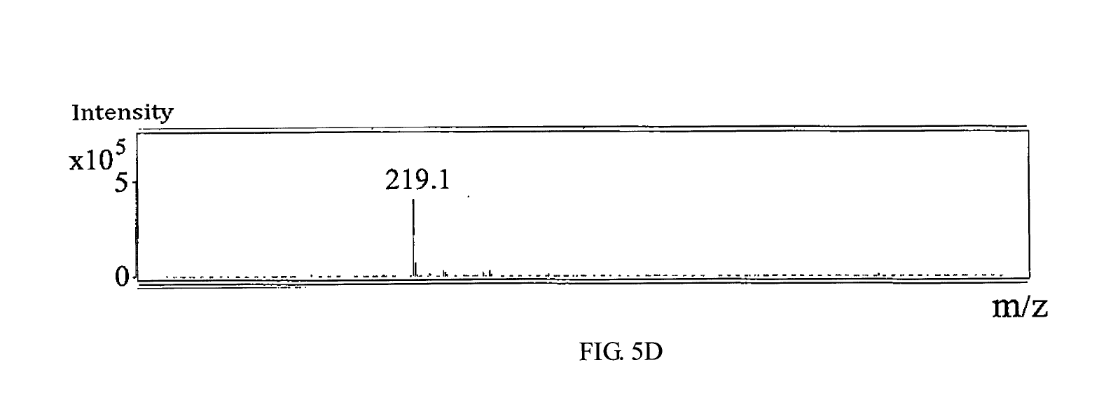

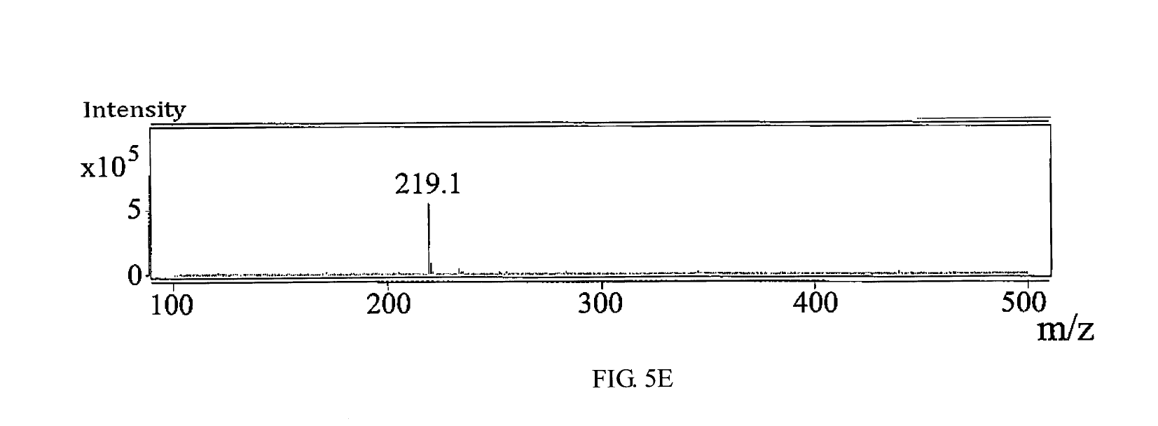

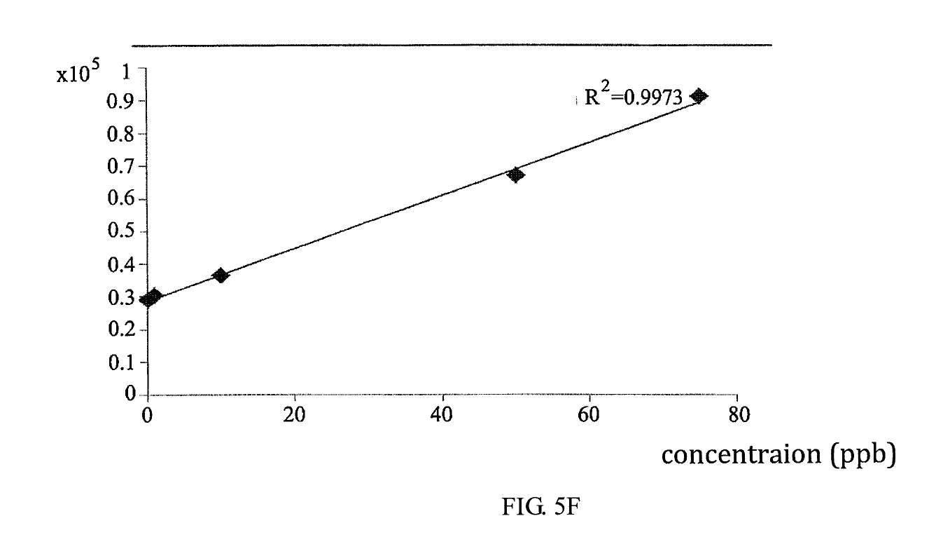

FIGS. 5A-5E show spectra obtained by using a plurality of the probes 331 in the invention to adsorb various concentrations of nonylphenol, of which the concentration is 100 ppt in FIG. 5A, the concentration is 1 ppb (parts per billion) in FIG. 5B, the concentration is 10 ppb in FIG. 5C, the concentration is 50 ppb in FIG. 5D, the concentration is 75 ppb in FIG. 5E, and a linear calibration curve (R2=0.9957) is obtained in FIG. 5F. The intensity is about 2.8×10³ in FIG. 5A, the intensity is about 1.1×10⁴ in FIG. 5B, the intensity is about 9.4×10⁴ in FIG. 5C, the intensity is about 4.1×10⁵ in FIG. 5D, and the intensity is about 5.6×10⁵ in FIG. 5E. It can be seen that the sensitivity in the present invention is high, and the experimental results are reproducible.

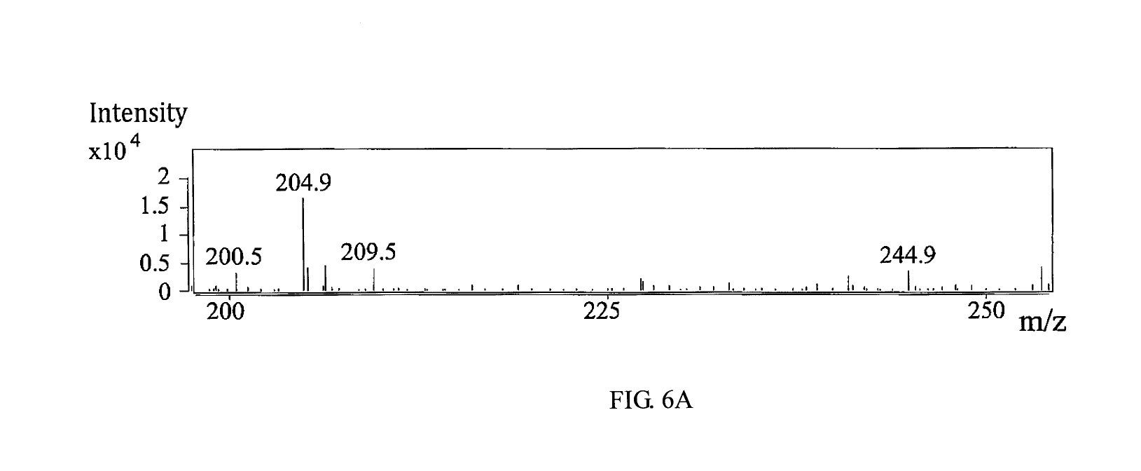

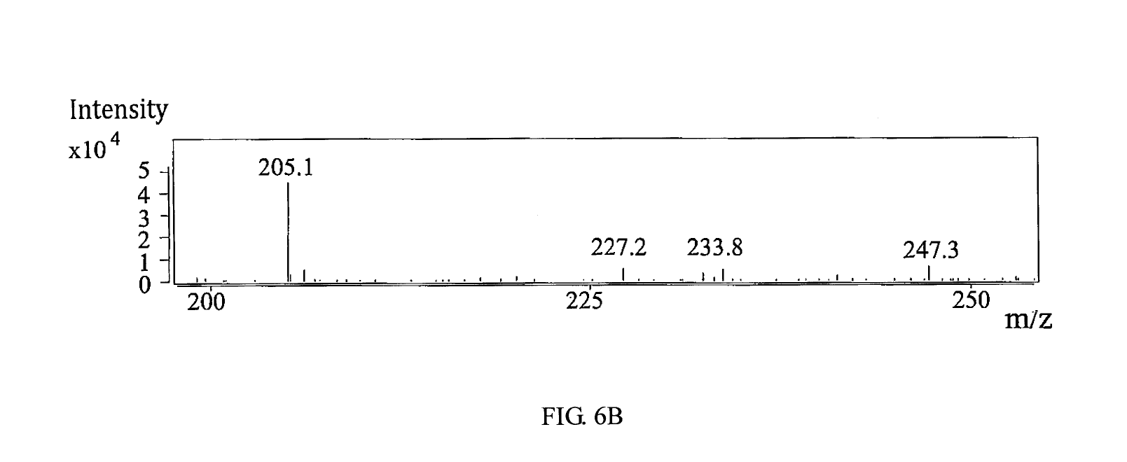

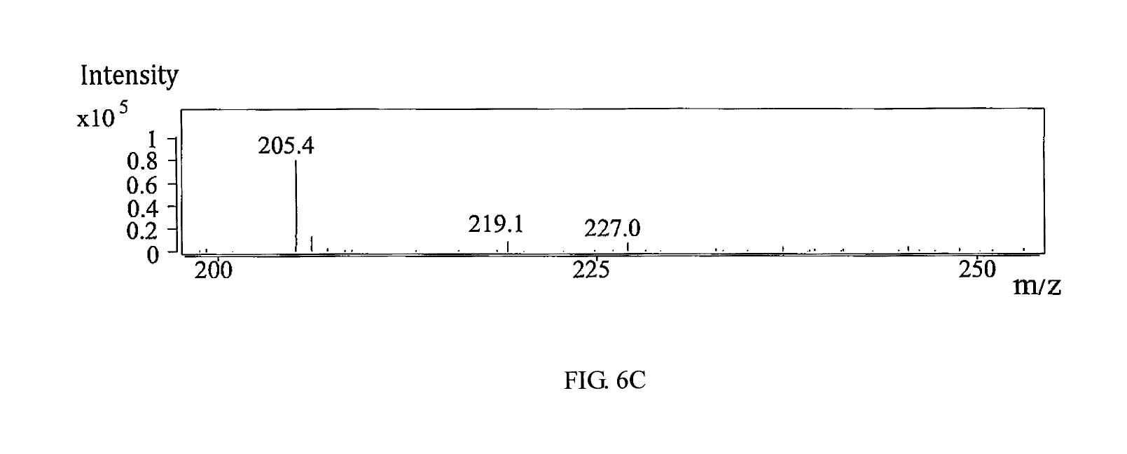

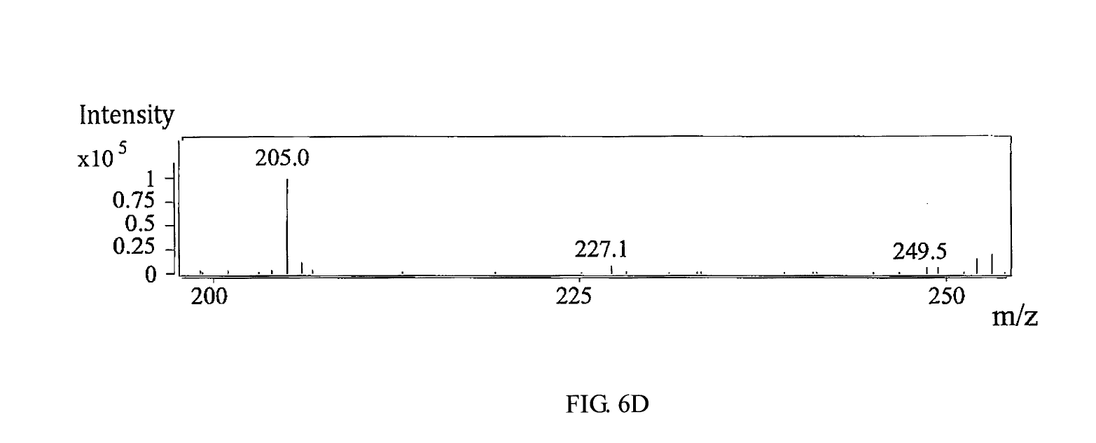

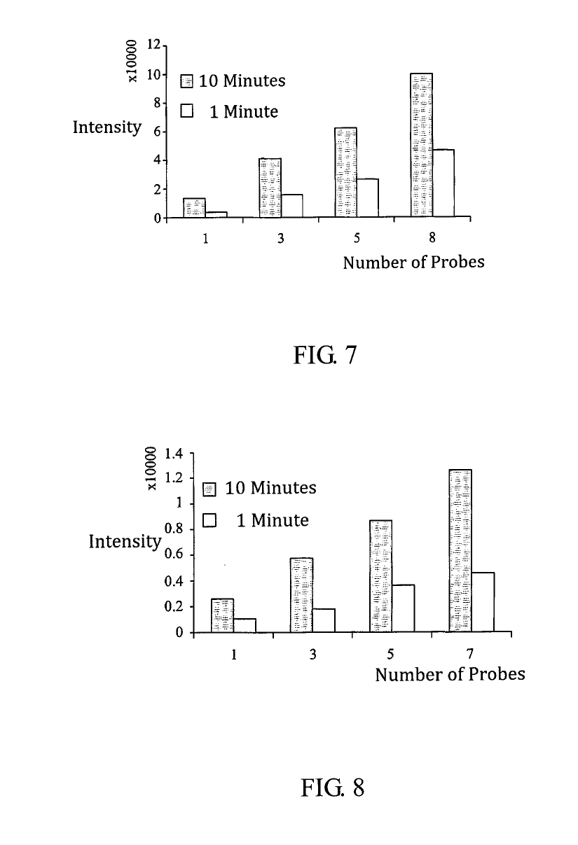

As shown in FIGS. 6A-6D, Ibuprofen is analyzed by the groups of the different numbers of the probes 331. It can be seen that the ionic intensities of mass spectrometry of Ibuprofen (EIC m/z 205) also increase linearly with the increase of the numbers of the probes 331. In FIG. 7 and FIG. 8, based on the experimental results of Ibuprofen for the different sample concentrations (100 ppb in FIGS. 7, and 10 ppb in FIG. 8), the duration which the probes 331 are placed in the analyte, and the different numbers of the probes 331, it can be seen that there are positive correlations of the experimental results with the increase of the numbers of the probes and with the increase of the duration of contact between the probes 331 and the analyte.

Since the amount of analytes extracted by the fibers of a plurality of the SPME probes 331 dependents on analyte concentration, it makes the SPME probes 331 an accurate and efficient sampling method for TD-ESI/MS. In addition, the analytes are desorbed inside the heating unit 31 and delivered into the charge producing unit 31, which can be implemented as an ESI plume, by a nitrogen gas stream from the air flow path 323 for postionization, it is favorable to reduce diffusion effects and concentrate these analytes during desorption and ionization rather than analyzing them in an open space. Furthermore, the ionization efficiency would be enhanced due to increases in reaction times and collision probabilities in a closed space. Those features make SPME/TD-ESI/MS/MS of the present invention a good tool to perform rapidly quantitative analysis for chemical compounds in aqueous solution.

In summary, an analyte in a liquid or solid state is extracted directly onto a plurality of probes 331 in the present invention, and then the probes 331 are inserted through the passage to instantly vaporize the analyte for ionization and mass spectrometry analysis, which shortens the analysis time of the analyte. Sampling with a plurality of the probes not only increases the sampling efficiency and the analysis sensitivity, but also detects different ingredients or materials in the same sample, so that the objects of the present invention are achieved.

The content described above is only a preferred embodiment of the invention, and can not be used to limit the scope of the present invention implementation. The various equivalent alternations and modifications in accordance with the claims and specification of the present invention are still within the scope covered by the present invention.

What is claimed is:

1. A thermal desorption ionization device having multiple solid phase micro-extraction probes, for desorbing an analyte and moving the analyte toward an entry of a mass spectrometer for mass spectrometry analysis, and comprising:
a charge producing unit disposed separately from the mass spectrometer and facing the entry of the mass spectrometer for producing charged solvent droplets;
a heating unit including a heating body and a passage penetrating through the heating body, wherein the passage includes a sample inlet and an outlet opposite to the sample inlet, and the outlet faces a space between the charge producing unit and the mass spectrometer, and an extending direction of the outlet intersects an extending direction of the charge producing unit; and
a sampling unit including a plurality of probes which are combined together, can be inserted into and pulled away from the passage of the heating unit, and can be attached by the analyte, wherein each of the probes comprises a material selected from a group consisting of a fused silica fiber and a metal fiber, and is coated with a polymeric adsorption material,
wherein the analyte on the probes passes from the sample inlet through the passage of the heating unit, and then the analyte is heated, desorbed into a gas state by the heating body and leaves the outlet, so that the analyte in the gas state reacts with the solvent droplets produced by the charge producing unit to generate charged analyte ions which then enters the entry of the mass spectrometer for analysis.

2. The thermal desorption ionization device as claimed in claim 1, wherein the heating unit further comprises an air flow path penetrating through a heating body and intersecting the passage.

3. The thermal desorption ionization device as claimed in claim 1, wherein the sampling unit further comprises a connector connecting one end of the probes, and a fixing portion connecting one end of the connector away from the probes, and wherein the fixing portion has a connecting area connecting the connector and facing the sample inlet, the connecting area is larger than the cross-section of the sample inlet.

4. The thermal desorption ionization device as claimed in claim 1, wherein the charge producing unit produces the charged solvent droplets in a spraying method, and the spraying method comprises a method selected from a group consisting of electrospray ionization, nanospray ionization, sonic spray ionization and thermal spray ionization.

5. The thermal desorption ionization device as claimed in claim 1, wherein the charge producing unit produces the charged solvent droplets in an electric discharge method, and the electric discharge method comprises a method selected from a group consisting of corona discharge, glow discharge and dielectric barrier discharge.

6. The thermal desorption ionization device as claimed in claim 1, wherein the heating temperature range of the heating body of the heating unit is from 40° C. to 1500° C.

7. The thermal desorption ionization device as claimed in claim 1, wherein the polymeric absorption material coated on each of the probes of the sampling unit comprises a material selected from a group consisting of polyacrylate and polydimethylsiloxane.

8. A mass spectrometer system for mass spectrometry analysis of an analyte, comprising:
a mass spectrometer including an entry for receiving and analyzing desorbed and ionized analyte ions;
a thermal desorption ionization device, comprising;
a charge producing unit disposed separately from the mass spectrometer and facing the entry of the mass spectrometer for producing charged solvent droplets;
a heating unit including a heating body and a passage penetrating through the heating body, wherein the passage includes a sample inlet and an outlet opposite to the sample inlet, and the outlet faces a space between the charge producing unit and the mass spectrometer, and an extending direction of the outlet intersects an extending direction of the charge producing unit; and
a sampling unit including a plurality of probes which are combined together, can be inserted into and pulled away from the passage of the heating unit and can be attached by the analyte, wherein each of the probes comprises a material selected from a group consisting of a fused silica fiber and a metal fiber, and is coated with a polymeric adsorption material,
wherein the analyte on the probes passes from the sample inlet through the passage of the heating unit, and then the analyte is heated, desorbed into a gas state by the heating body and leaves the outlet, so that the analyte reacts with the solvent droplets produced by the charge producing unit to generate the charged analyte ions, and enters the entry of the mass spectrometer for analysis.

9. The mass spectrometer system as claimed in claim 8, wherein the heating unit further comprises an air flow path penetrating through a heating body and intersecting the passage.

10. The mass spectrometer system as claimed in claim 8, wherein the sampling unit further comprises a connector connecting one end of the probes, and a fixing portion connecting one end of the connector away from the probes, and the fixing portion has a connecting area connecting the connector and facing the sample inlet, the connecting area is larger than the cross-section of the sample inlet.

11. The mass spectrometer system as claimed in claim 8, wherein the charge producing unit produces the charged solvent droplets in a spraying method, and the spraying method comprises a method selected from a group consisting of electrospray ionization, nano ionization, sonic spray ionization and thermal spray ionization.

12. The mass spectrometer system as claimed in claim 8, wherein the charge producing unit produces the charged solvent droplets in an electric discharge method, and the electric discharge method comprises a method selected from the group consisting of corona discharge, glow discharge and dielectric barrier discharge.

13. The mass spectrometer system as claimed in claim 8, wherein the polymeric absorption material coated on each of the probes of the sampling unit comprises a material selected from a group consisting of polyacrylate and polydimethylsiloxane.

14. The mass spectrometer system as claimed in claim 8, wherein the heating temperature range of the heating body of the heating unit is from 40° C. to 1500° C.

15. An analytical method of mass spectrometry, comprising steps of:
sampling by attaching an analyte to a plurality of probes combined together, wherein each of the probes comprises a material selected from a group consisting of a fused silica fiber and a metal fiber, and is coated with a polymeric adsorption material;
desorbing by inserting the probes into a passage penetrating through a heating body, wherein the analyte attached to the probes is heated, desorbed into a gas state by the heating body, and leaves the passage;
producing charges by a charge producing unit which faces to an entry of a mass spectrometer in order to produce charged solvent droplets, wherein the analyte in the gas state and the solvent droplets are fused to generate the charged analyte ions; and
analyzing the analyte, wherein the analyte ions enter the mass spectrometer via the entry, and are analyzed by the mass spectrometer.

16. The method as claimed in claim 15, wherein the polymeric absorption material coated on each of the probes of the sampling unit comprises a material selected from a group consisting of polyacrylate and polydimethylsiloxane.
